(19) United States
(12) Patent Application Publication
(10) Pub. No.: US 2012/0243821 A1
(43) Pub. Date: Sep. 27, 2012

(54) TUNABLE OPTICAL FILTER UTILIZING A LONG-RANGE SURFACE PLASMON POLARITON WAVEGUIDE TO ACHIEVE A WIDE TUNING RANGE

(75) Inventors: Mikhail Belkin, Austin, TX (US); Jongwon Lee, Austin, TX (US)

(73) Assignee: BOARD OF REGENTS, THE UNIVERSITY OF TEXAS SYSTEM, Austin, TX (US)

(21) Appl. No.: 13/426,329

(22) Filed: Mar. 21, 2012

Related U.S. Application Data
(60) Provisional application No. 61/466,330, filed on Mar. 22, 2011.

(51) Int. Cl. G02B 6/00; G02B 5/28; B82Y 20/00

(52) U.S. Cl. 385/11; 359/578; 977/834

(57) ABSTRACT

An optical filter and a method for fabricating an optical filter with a wide tuning range and a structure subject to miniaturization. The optical filter includes a bottom and a top dielectric layer with a stripe or film of metal between the dielectric layers which have dissimilar refractive index dispersion. The stripe of metal functions as a waveguide supporting a long-range surface plasmon polariton mode which will be achieved at wavelengths for which the refractive indices of the dielectric layers are the same thereby providing a bandpass filter. Furthermore, one of the dielectric layers is made of a material that allows its refractive index to be tuned, such as by changing its applied voltage or temperature. By tuning the refractive index of the dielectric layer, the wavelength at which the refractive indices of the dielectric layers match changes thereby effectively tuning the optical filter.

### CROSS-REFERENCE TO RELATED APPLICATIONS

This application is related to the following commonly owned co-pending U.S. patent application:

Provisional Application Ser. No. 61/466,330, “Tunable Optical Filters Based on Long-Range Surface Plasmon-Polariton Waveguides,” filed Mar. 22, 2011, and claims the benefit of its earlier filing date under 35 U.S.C. §119(e).

### TECHNICAL FIELD

The present invention relates generally to optical filters, and more particularly to a tunable optical filter utilizing a long-range surface plasmon polariton waveguide to achieve a wide tuning range.

### BACKGROUND

Optical filters are devices which selectively transmit light of different wavelengths. The tuning range (δλ) of modern compact solid-state optical filters, such as Bragg and micro-resonator filters, are limited by the possible refractive index variation (δn) of the filter medium:

$$\frac{δ λ}{λ} = \frac{δ n}{ n} \qquad ( EQ 1 )$$

where n is the refractive index of the filter medium and λ is the center wavelength of operation. Since δn is very limited for electro-optic materials and even liquid crystals, the tuning range of such filters is very limited. Diffraction gratings, acousto-optic, and multi-stage birefringent liquid-crystal-tunable filters may provide broader tuning; however, these filters require either a mechanical rotation (grating), or an external acoustic wave generator (acousto-optic), or have a complex and bulky multi-stage structure, all of which prevents their miniaturization. In addition, since these filters are all based on diffraction and/or interference phenomena, they cannot provide continuous bandpass tuning over more than one optical octave.

Hence, the tuning range of current optical filters is limited with structures that may be complex thereby preventing their miniaturization.

### BRIEF SUMMARY

In one embodiment of the present invention, an optical filter comprises a first dielectric layer. The optical filter further comprises a stripe of metal on the first dielectric layer. In addition, the optical filter comprises a second dielectric layer on the stripe of metal. The first and second dielectric layers have dissimilar optical dispersions for transverse magnetic polarized light. Furthermore, one of the first second dielectric layers is configured to vary its refractive index based voltage or temperature. In addition, the stripe of metal functions as a waveguide supporting a long-range surface plasmon polariton mode, where a transmission of surface plasmon polariton waves is highest when the first and second dielectric layers have a same index of refraction.

In another embodiment of the present invention, a device comprises an optical filter comprising a first dielectric layer. The optical filter further comprises a stripe of metal on the first dielectric layer. In addition, the optical filter comprises a second dielectric layer on the stripe of metal. The first and second dielectric layers have dissimilar optical dispersions for transverse magnetic polarized light. Furthermore, one of the first second dielectric layers is configured to vary its refractive index based voltage or temperature. In addition, the stripe of metal functions as a waveguide supporting a long-range surface plasmon polariton mode, where a transmission of surface plasmon polariton waves is highest when the first and second dielectric layers have a same index of refraction. Additionally, the device comprises a polarization-matching fiber connected to an input of the optical filter. In addition, the device comprises a single-mode fiber connected to an output of the optical filter.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE SEVERAL VIEWS OF THE DRAWINGS

A better understanding of the present invention can be obtained when the following detailed description is considered in conjunction with the following drawings, in which:

FIG. 1 is a flowchart of a method for fabricating an optical filter utilizing a long-range surface plasmon polariton waveguide to achieve a wide tuning range in accordance with an embodiment of the present invention of a network system;

FIGS. 2A-2D depict cross-sectional views of the optical filter during the fabrication steps described in FIG. 1 in accordance with an embodiment of the present invention;

FIGS. 3A-3C are plots of the coupling loss, propagation loss and total optical loss versus the refractive index mismatch for various widths and thicknesses of the stripe of metal of the optical filter in accordance with an embodiment of the present invention;

FIG. 4 is a plot of the refractive index as a function of wavelength for the dielectric layers of the optical filter in accordance with an embodiment of the present invention;

FIG. 5 illustrates the transmission curves for an illustrative optical filter in accordance with an embodiment of the present invention;

FIG. 6 illustrates a structure for narrowing the transmission band in accordance with an embodiment of the present invention; and

FIG. 7 illustrates a structure for increasing the transmission while maintaining the transmission band in accordance with an embodiment of the present invention.

### DETAILED DESCRIPTION

The present invention comprises an optical filter and a method for fabricating an optical filter with a wide tuning range and a structure subject to miniaturization. In one embodiment of the present invention, the optical filter includes a bottom and a top dielectric layer with a stripe or film of metal between the dielectric layers which have dissimilar refractive index dispersion. The stripe of metal functions as a waveguide supporting a long-range surface plasmon polariton mode which will be achieved at wavelengths for which the refractive indices of the dielectric layers are the same thereby providing a bandpass filter. Furthermore, one of the dielectric layers is made of a material that allows its refractive index to be tuned, such as by changing its applied voltage or temperature. By tuning the refractive index of the dielectric layer, the wavelength at which the refractive indices of the dielectric layers match changes thereby effectively tuning the optical filter. By developing an optical filter with such a structure, the optical filter has a wide tuning range and is subject to miniaturization.

As stated in the Background section, optical filters are devices which selectively transmit light of different wavelengths. The tuning range of modern compact solid-state optical filters, such as Bragg and micro-resonator filters, are limited by the possible refractive index variation of the filter medium. Diffraction gratings, acousto-optic, and multi-stage birefringent liquid-crystal-tunable filters may provide broader tuning; however, these filters require either a mechanical rotation (grating), or an external acoustic wave generator (acousto-optic), or have a complex and bulky multi-stage structure, all of which prevents their miniaturization. In addition, since these filters are all based on diffraction and/or interference phenomena, they cannot provide continuous bandpass tuning over more than one optical octave. Hence, the tuning range of current optical filters is limited with structures that may be complex thereby preventing their miniaturization.

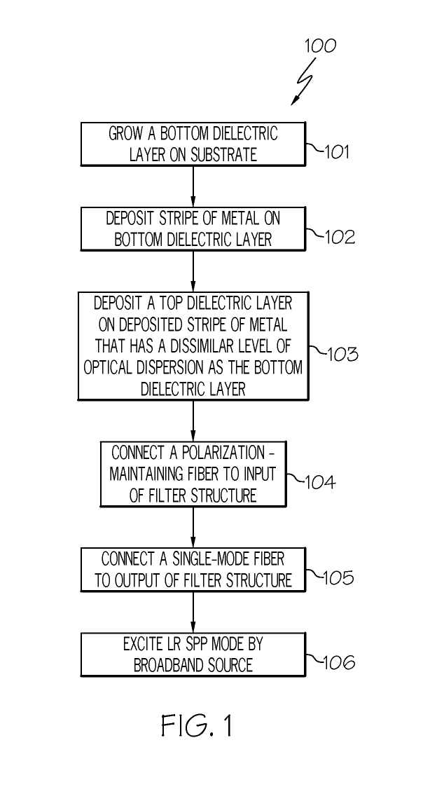

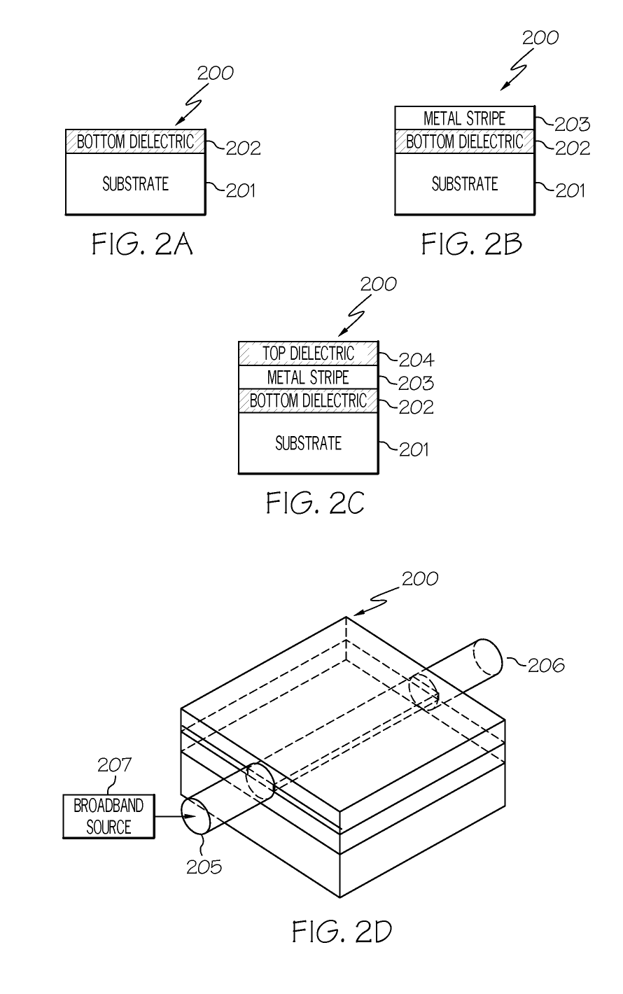

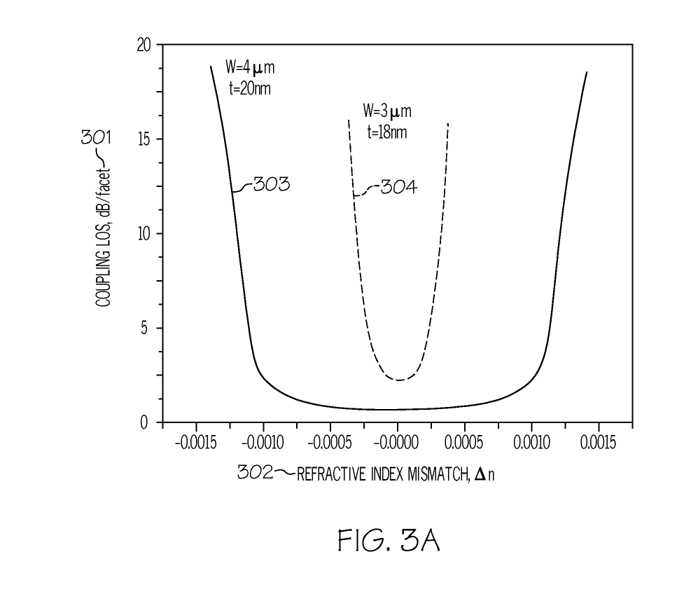

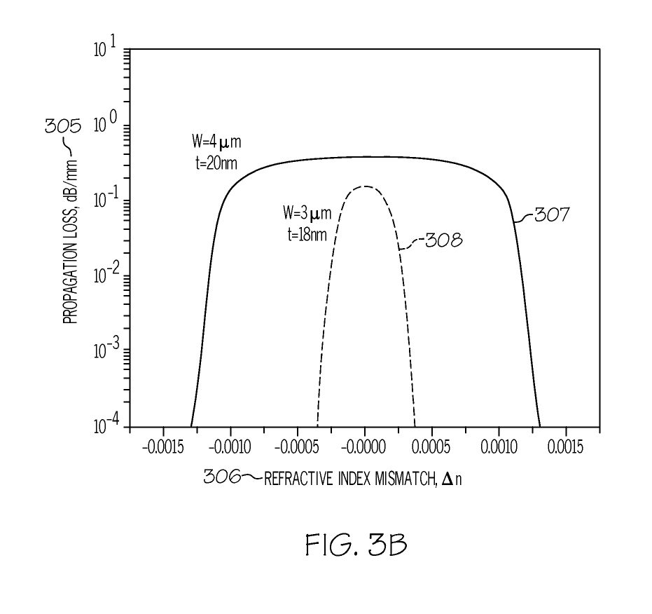

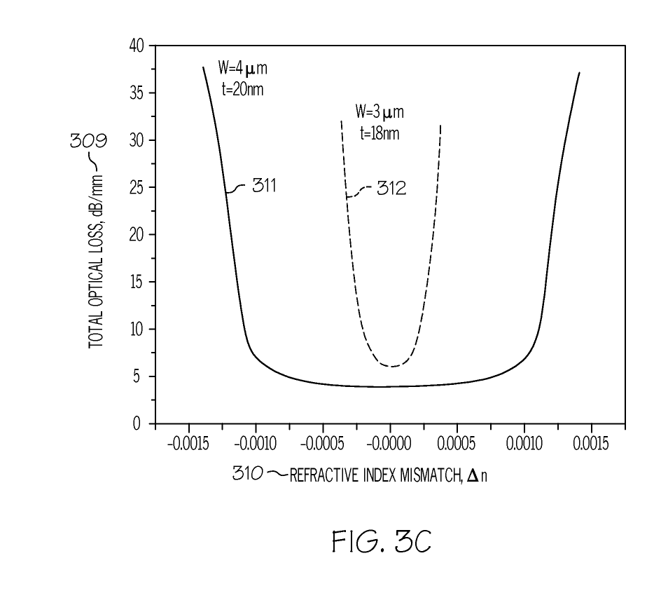

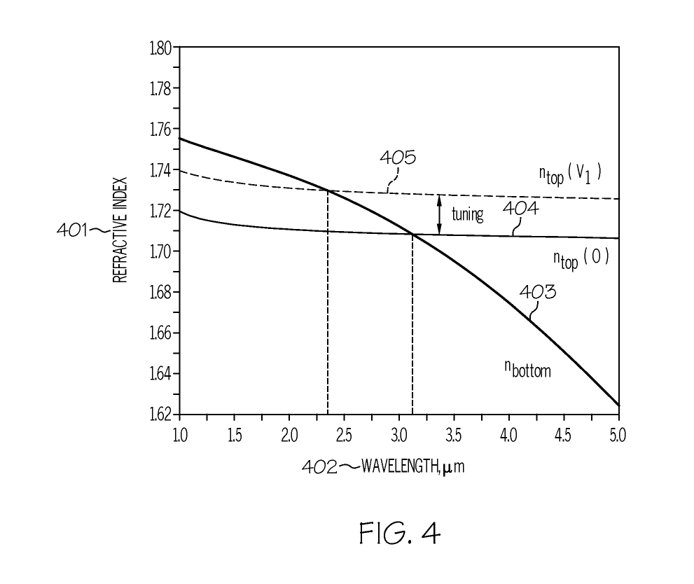

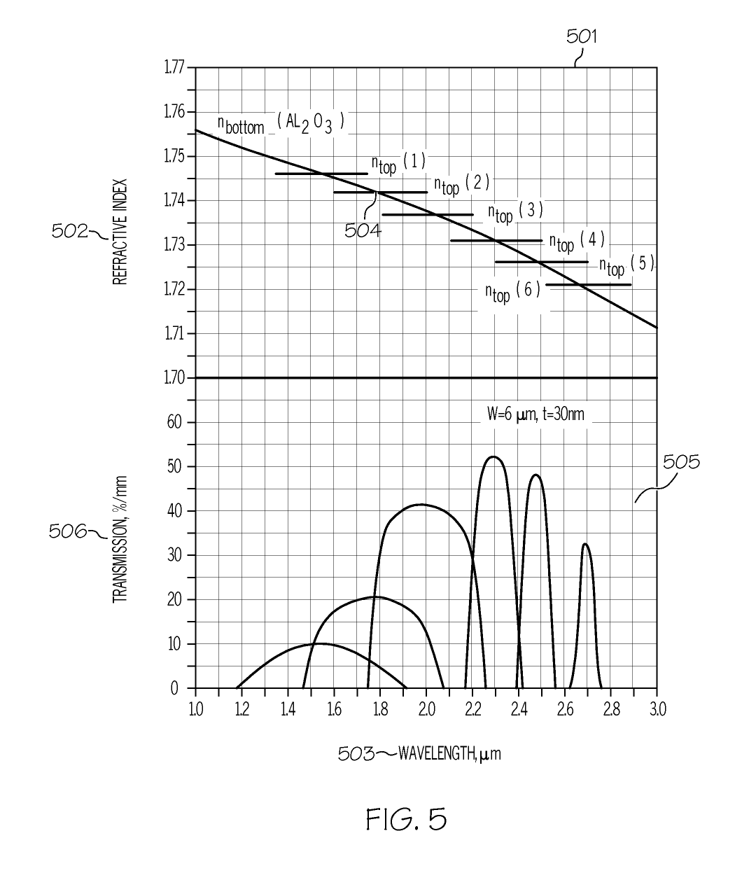

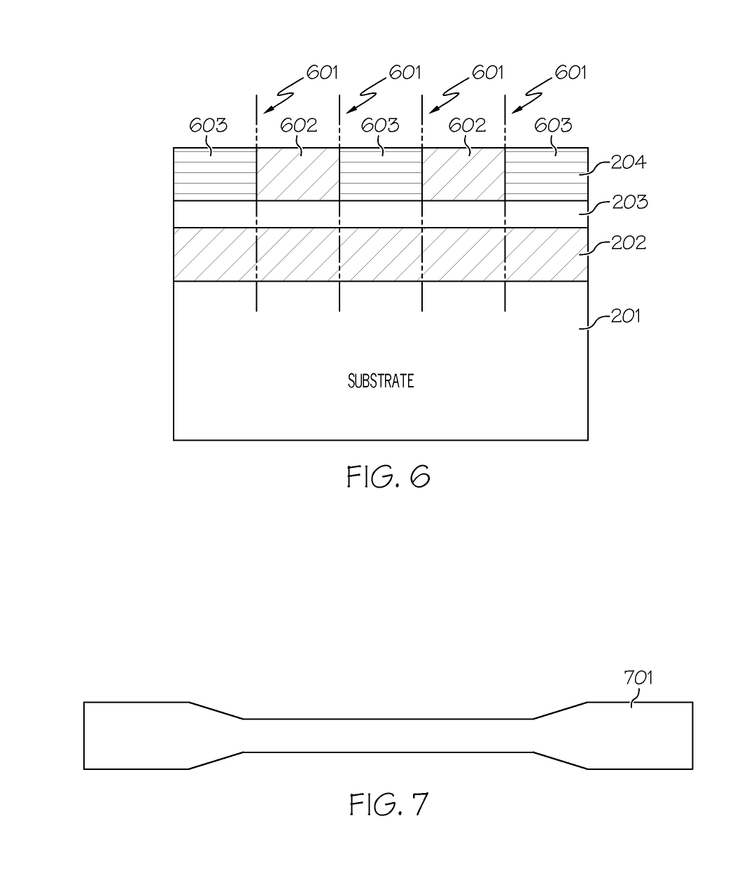

The principles of the present invention provide an optical filter that utilizes a long-range surface plasmon polariton waveguide to achieve a wide tuning range with a structure that can be miniaturized in comparison to previously designed optical filters as discussed below in connection with FIGS. 1, 2A-2D, 3A-3C and 4-7. FIG. 1 is a flowchart of a method for fabricating an optical filter that utilizes a long-range surface plasmon polariton waveguide to achieve a wide tuning range. FIGS. 2A-2D depict cross-sectional views of the optical filter during the fabrication steps described in FIG. 1. FIGS. 3A-3C are plots of the coupling loss, propagation loss and total optical loss versus the refractive index mismatch for various widths and thicknesses of the stripe of metal of the optical filter. FIG. 4 is a plot of the refractive index as a function of wavelength for the dielectric layers of the optical filter. FIG. 5 illustrates the transmission curves for an illustrative optical filter. FIG. 6 illustrates a structure for narrowing the transmission band. FIG. 7 illustrates a structure for increasing the transmission while maintaining the transmission band.

Referring now to the Figures in detail, FIG. 1 is a flowchart of a method 100 for fabricating an optical filter that utilizes a long-range surface plasmon polariton waveguide to achieve a wide tuning range in accordance with an embodiment of the present invention. FIG. 1 will be discussed in conjunction with FIGS. 2A-D, which depict cross-sectional views of optical filter 200 during the fabrication steps described in FIG. 1 in accordance with an embodiment of the present invention.

Referring to FIG. 1, in conjunction with FIGS. 2A-D, in step 101, a dielectric layer 202 (indicated as “bottom dielectric” in FIG. 2A) is grown on a substrate 201 (e.g., silicon) as illustrated in FIG. 2A. In one embodiment, dielectric layer 202 is thermally grown on substrate 201. In one embodiment, the material of dielectric layer 202 is aluminum oxide (Al₂O₃) when optical filter 200 is operating in the 3-5 μm spectral range. In one embodiment, the material of dielectric layer 202 is zinc selenide (ZnSe), zinc sulfide (ZnS) and barium fluorine (BaF) when optical filter 200 is operating in the 8-12 μm spectral range. In one embodiment, the material of substrate 201 is silicon carbide (SiC). In one embodiment, substrate 201 corresponds to dielectric layer 202. In such an embodiment, dielectric layer 202 is not grown on substrate 201 but instead represents substrate 201.

In step 102, a stripe or film of metal 203 is deposited on dielectric layer 202 as illustrated in FIG. 2B. In one embodiment, the material of metal stripe 203 is gold (Au). In one embodiment, metal stripe 203 has a thickness between 10-30 nm, a width between 1-10 μm and a length between 1-10 mm.

In one embodiment, metal stripe 203 is configured to function as a waveguide guiding surface plasmon polariton (SPP) waves. SPP waves may be used as information carriers due to their ability to localize electromagnetic fields on a subwavelength scale. Surface plasmon polaritons are infrared or visible frequency electromagnetic waves trapped at or guided along metal-dielectric interfaces, such as between metal stripe 203 and dielectric layer 202 or between metal stripe 203 and dielectric layer 204 (discussed further below). That is, surface plasmon polaritons are electromagnetic excitations coupled to electron oscillations propagating in a wavelike fashion along a metal-dielectric interface, such as between metal stripe 203 and dielectric layer 202 or between metal stripe 203 and dielectric layer 204 (discussed further below). A more detailed discussion of metal stripe 203 being used as a waveguide for SPP waves is provided further below.

In step 103, a dielectric layer 204 (indicated as “top dielectric” in FIG. 2C) is deposited on metal stripe 203 as illustrated in FIG. 2C, where the optical dispersion (i.e., the refractive index dispersion) for dielectric layer 204 is dissimilar from dielectric layer 202. In one embodiment, dielectric layer 202 has a high optical dispersion for transverse magnetic polarized light; whereas, dielectric layer 204 has a relatively low optical dispersion for transverse magnetic polarized light. In another embodiment, dielectric layer 204 has a high optical dispersion for transverse magnetic polarized light; whereas, dielectric layer 202 has a relatively low optical dispersion for transverse magnetic polarized light. In one embodiment, the material of dielectric layer 204 includes liquid crystals. In another embodiment, the material of dielectric layer 204 is lithium iodate (LiIO₃). By having a dielectric layer, such as dielectric layer 204, be made of a material, such as liquid crystal material or lithium iodate, the refractive index can be varied or tuned for transverse magnetic polarized light, such as by changing its applied voltage or temperature. While the description herein discusses the use of lithium iodate or liquid crystal materials in providing refractive index tuning, it is noted that the principles of the present invention are not to be limited to such materials. The principles of the present invention apply to other materials, such as those with significant electro-optic coefficients based on intersubband transitions in quantum wells.

Furthermore, while the description herein discusses dielectric layer 204 as being used for providing refractive index tuning, it is noted that the other dielectric layer, dielectric layer 202, may instead be used to provide refractive index tuning. In such an embodiment, the material of dielectric layer 202 will include the materials discussed above in connection with dielectric layer 204. Furthermore, in such an embodiment, the material of dielectric layer 204 will include the materials discussed above in connection with dielectric layer 202.

Following steps 101-103, optical filter 200 may then be coupled to a broadband source so as to selectively transmit light of different wavelengths as discussed below in steps 104-106.

In step 104, a polarization-maintaining fiber 205 (i.e., fiber that maintains the orientation of the oscillating light wave) is connected to the input of the structure of optical filter 200 as illustrated in FIG. 2D.

In step 105, a single-mode fiber 206 (optical fiber that is designed to carry only a single ray of light) is connected to an output of optical filter 200 as illustrated in FIG. 2D.

In step 106, the long-range surface plasmon polariton mode (LR SPP mode) is excited by a broadband source 207 (e.g., quantum cascade laser) connected to polarization-maintaining fiber 205 as illustrated in FIG. 2D.

As discussed above, metal stripe 203 is integrated between two dielectric layers 202, 204 of dissimilar refractive index dispersion. As a result of such an implementation, a low-loss long-range surface plasmon polariton mode will be achieved at wavelengths for which the refractive indices of the two dielectric layers 202, 204 are the same thereby providing a bandpass filter as discussed below in connection with FIGS. 3A-3C and 4-5.

FIGS. 3A-3C are plots of the coupling loss, propagation loss and total optical loss versus the refractive index mismatch (i.e., the differences in the refractive indices of dielectric layers 202, 204) (indicated by Δn) for various widths and thicknesses of metal stripe 203 in accordance with an embodiment of the present invention. The total optical loss consists of both the coupling loss and the propagation loss. FIGS. 3A-3C and 4-5 will be discussed in conjunction with the illustrative embodiment of having dielectric layer 202 being a material with a high optical dispersion for transverse magnetic polarized light and dielectric layer 204 being a material that can tune its refractive index for transverse magnetic polarized light by changing its applied voltage and having a relatively low optical dispersion for transverse magnetic polarized light. Furthermore, FIGS. 3A-3C and 4-5 will be discussed in conjunction with the illustrative embodiment of having dielectric layer 202 being made of aluminum oxide and dielectric layer 204 being made of lithium iodate.

Turning now to FIG. 3A, in conjunction with FIGS. 1 and 2A-2D, FIG. 3A is a plot of the coupling loss 301 (in dB/facet) versus the refractive index mismatch 302 (i.e., the differences in the refractive indices of dielectric layers 202, 204) (indicated by Δn) for various widths and thicknesses of metal stripe 203 in accordance with an embodiment of the present invention. When there is a mismatch between the refractive indices of dielectric layers 202, 204, the coupling loss greatly increases. Plot 303 shows the coupling losses for the waveguide supported by metal stripe 203 as a function of the refractive index difference between dielectric layers 202, 204 for metal stripe 203 having a width of 4 μm and a thickness of 20 nm. Plot 304 shows the coupling losses for the waveguide supported by metal stripe 203 as a function of the refractive index difference between dielectric layers 202, 204 for metal stripe 203 having a width of 3 μm and a thickness of 18 nm. As discussed above, the total optical loss consists of both the coupling loss and the propagation loss. The coupling loss originates from mode mismatch between the optical fiber mode (either single-mode fiber 206 or polarization-maintaining fiber 205) and LR SPP mode. This coupling loss mainly contributes to the total optical loss. As the index mismatch increases, the LR SPP mode becomes more distorted and then the mode mismatch between the optical fiber mode and the LR SPP mode greatly increases thereby increasing the coupling loss rapidly.

FIG. 3B is a plot of the propagation loss 305 (in dB/mm) versus the refractive index mismatch 306 (i.e., the differences in the refractive indices of dielectric layers 202, 204) (indicated by Δn) for various widths and thicknesses of metal stripe 203 in accordance with an embodiment of the present invention. Plot 307 shows the propagation losses for the waveguide supported by metal stripe 203 as a function of the refractive index difference between dielectric layers 202, 204 for metal stripe 203 having a width of 4 μm and a thickness of 20 nm. Plot 308 shows the coupling losses for the waveguide supported by metal stripe 203 as a function of the refractive index difference between dielectric layers 202, 204 for metal stripe 203 having a width of 3 μm and a thickness of 18 nm. As illustrated in FIG. 3B, as the index mismatch increases, the LR SPP mode spreads out and the propagation loss decreases.

FIG. 3C is a plot of the total optical loss 309 (in dB/mm) versus the refractive index mismatch 310 (i.e., the differences in the refractive indices of dielectric layers 202, 204) (indicated by Δn) for various widths and thicknesses of metal stripe 203 in accordance with an embodiment of the present invention. The long-range surface plasmon polariton waveguide as supported by metal stripe 203 will have high transmission (i.e., minimum optical loss) of SPP waves only at the wavelengths for which the refractive index of dielectric layer 202 matches the refractive index of dielectric layer 204 (indicated by Δn equaling zero). When there is a mismatch between the refractive indices of dielectric layers 202, 204, the optical loss greatly increases. Plot 311 shows the total optical losses for the waveguide supported by metal stripe 203 as a function of the refractive index difference between dielectric layers 202, 204 for metal stripe 203 having a width of 4 μm and a thickness of 20 nm. Plot 312 shows the total optical losses for the waveguide supported by metal stripe 203 as a function of the refractive index difference between dielectric layers 202, 204 for metal stripe 203 having a width of 3 μm and a thickness of 18 nm.

FIG. 4 is a plot of the refractive index 401 as a function of wavelength 402 (in μm) for dielectric layers 202, 204 (FIGS. 2A-2D) in accordance with an embodiment of the present invention. Referring to FIG. 4, in conjunction with FIGS. 1 and 2A-2D, plot 403 represents the change in the refractive index (indicated by n_{bottom}) versus wavelength for the material of aluminum oxide for dielectric layer 202. Plot 404 represents the change in the refractive index (indicated by nₜₒₚ(0)) versus wavelength for the material of lithium iodate for dielectric layer 204. For the wavelength of 3 μm, the refractive index of dielectric layers 202, 204 match. As discussed above, in one embodiment, dielectric layer 204 includes a material, such as liquid crystal material or lithium iodate, which allows dielectric layer 204 to tune its refractive index by changing its applied voltage. As illustrated in FIG. 4, when the voltage applied to dielectric layer 204 changes, the refractive index of dielectric layer 204 changes as illustrated by plot 405 (indicated by nₜₒₚ(V₁)) thereby shifting the wavelength (now wavelength of 2.5 μm) at which the refractive index of dielectric layers 202, 204 match.

FIG. 5 illustrates the transmission curves for optical filter 200 (FIGS. 2A-2D) in accordance with an embodiment of the present invention. Referring to FIG. 5, in conjunction with FIGS. 1 and 2A-2D, the top panel 501 illustrates the refractive index 502 as a function of wavelength 503 (in μm). In particular, top panel shows the refractive index dispersion curve 504 of aluminum oxide for dielectric layer 202 (black continuous line) and different values of the refractive index (short horizontal lines) for dielectric layer 204 based on changes in the applied voltage with negligible dispersion. Bottom panel 505 shows the calculated transmission 506 (as a percentage/mm) of optical filter 200 having a length of 1 mm with its metal stripe 203 having the material of gold as well as having a thickness of 30 nm and a width of 6 μm for each value of the index of refractive of dielectric layer 204 (nₜₒₚ). As illustrated in FIG. 5, when the refractive indices of dielectric layers 202, 204 match, the transmission of SPP waves is highest. FIG. 5 further illustrates that the filter performance improves considerably at longer wavelengths as optical properties of metals become more favorable. Furthermore, it is noted that the appropriate filter bandwidth at a certain wavelength can be designed by adjusting the dimensions of metal stripe 203. For example, wider and thicker metal stripes 203 become more suitable for longer wavelengths (i.e., the filter transmission trend illustrated in FIG. 5 will be shifted to longer wavelengths for wider and thicker metal stripes 203).

As a result of integrating metal stripe 203 between two dielectric layers 202, 204 with dissimilar refractive index dispersion, the low-loss long-range surface plasmon polariton mode will be possible at wavelengths for which the refractive indices of dielectric layers 202, 204 are the same thereby leading to a bandpass filter as discussed above. Tuning the refractive index curve of one of the dielectric layers, such as dielectric layer 204, such as by temperature, applied voltage or other means, will lead to a large shift in the bandpass of filter 200. The bandpass may be continuously tunable over multiple optical octaves and optical filter 200 may operate in visible-near-infrared, mid-infrared, and far-infrared spectral ranges (e.g., 500 nm-300 μm).

Such an optical filter as discussed above has numerous applications, such as spectroscopic imaging and sensing, fiber optics, free space communications, and integration with quantum cascade or diode lasers to create highly-compact broadly-tunable laser systems.

In one embodiment, a stacking structure, such as having a waveguide structure stacked on top of optical filter 200 which is stacked on top of another waveguide structure which is stacked on top of another optical filter 200 and so forth may be implemented to make the bandpass narrower.

In some implementations, method 100 may include other and/or additional steps that, for clarity, are not depicted. Further, in some implementations, method 100 may be executed in a different order presented and that the order presented in the discussion of FIG. 1 is illustrative. Additionally, in some implementations, certain steps in method 100 may be executed in a substantially simultaneous manner or may be omitted.

In order to increase filter performance (i.e., narrower transmission band or higher transmission), there are many possible approaches. For example, referring to FIG. 6, FIG. 6 illustrates a structure for narrowing the transmission band in accordance with an embodiment of the present invention. As illustrated in FIG. 6, in conjunction with FIGS. 2A-2D, gratings 601 are patterned into optical filter 200 from the top surface of top dielectric 204 to the interface of bottom dielectric 202/substrate 201. Dented spaces 602 in top dielectric layer 204 are filled with the same material as bottom dielectric 202. The other remaining spaces 603 of top dielectric layer 204 are filled with the material discussed above in connection with top dielectric layer 204. As a result of such a structure, a mode transition occurs, such as at the transitions (gratings 601) between spaces 602 and 603. In such a structure, a many mode transition surface (i.e., multiple coupling losses) is created which results in a narrower transmission band.

Referring to FIG. 7, FIG. 7 illustrates a structure for increasing the transmission while maintaining the transmission band in accordance with an embodiment of the present invention. The coupling loss of a metal stripe having a thickness of 20 nm and a width of 8 μm is much lower than the coupling loss for the metal stripe having a thickness of 20 nm and a width of 4 μm. However, the metal stripe having the thickness of 20 nm and the width of 4 μm is more sensitive to index mismatch than the metal stripe having the thickness of 20 nm and the width of 8 μm. Hence, as illustrated in FIG. 7, if metal stripe 701 started with a width of 8 μm and was tapered to 4 μm and then widened to 8 μm, then there is a decrease in coupling loss leading to a higher transmission while maintaining the transmission bandwidth.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. An optical filter, comprising:
a first dielectric layer;
a stripe of metal on said first dielectric layer; and
a second dielectric layer on said stripe of metal;
wherein said first and said second dielectric layers have dissimilar optical dispersions for transverse magnetic polarized light, wherein one of said first and said second dielectric layers is configured to vary its refractive index based on one of the following: voltage and temperature, wherein said stripe of metal functions as a waveguide supporting a long-range surface plasmon polariton mode, wherein a transmission of surface plasmon polariton waves is highest when said first and said second dielectric layers have a same index of refraction.

2. The optical filter as recited in claim 1, wherein said stripe of metal has a thickness between 10 and 30 nanometers.

3. The optical filter as recited in claim 1, wherein losses in said waveguide are greater when said first and said second dielectric layers do not have the same index of refraction than when said first and said second dielectric layers have the same index of refraction.

4. The optical filter as recited in claim 1, wherein said first dielectric layer comprises one of the following: aluminum oxide, zinc selenide, zinc sulfide and barium fluorine.

5. The optical filter as recited in claim 1, wherein said second dielectric layer comprises lithium iodate.

6. The optical filter as recited in claim 1, wherein said first dielectric layer comprises aluminum oxide, wherein said second dielectric layer comprises lithium iodate.

7. The optical filter as recited in claim 1, wherein one of said first and said second dielectric layers comprises liquid crystals.

8. The optical filter as recited in claim 1, wherein said first dielectric layer is thermally grown on a substrate, wherein said substrate comprises silicon carbide.

9. The optical filter as recited in claim 1, wherein said long-range surface plasmon polariton mode is excited by a quantum cascade laser.

10. A device, comprising:
an optical filter comprising:
a first dielectric layer;
a stripe of metal on said first dielectric layer; and
a second dielectric layer on said stripe of metal;
wherein said first and said second dielectric layers have dissimilar optical dispersions for transverse magnetic polarized light, wherein one of said first and said second dielectric layers is configured to vary its refractive index based on one of the following: voltage and temperature, wherein said stripe of metal functions as a waveguide supporting a long-range surface plasmon polariton mode, wherein a transmission of surface plasmon polariton waves is highest when said first and said second dielectric layers have a same index of refraction;
a polarization-matching fiber connected to an input of said optical filter; and
a single-mode fiber connected to an output of said optical filter.

11. The device as recited in claim 10, wherein said stripe of metal has a thickness between 10 and 30 nanometers.

12. The device as recited in claim 10, wherein losses in said waveguide are greater when said first and said second dielectric layers do not have the same index of refraction than when said first and said second dielectric layers have the same index of refraction.

13. The device as recited in claim 10, wherein said first dielectric layer comprises one of the following: aluminum oxide, zinc selenide, zinc sulfide and barium fluorine.

14. The device as recited in claim 10, wherein said second dielectric layer comprises lithium iodate.

15. The device as recited in claim 10, wherein said first dielectric layer comprises aluminum oxide, wherein said second dielectric layer comprises lithium iodate.

16. The device as recited in claim 10, wherein one of said first and said second dielectric layers comprises liquid crystals.

17. The device as recited in claim 10, wherein said long-range surface plasmon polariton mode is excited by a quantum cascade laser.
